(19) United States
(12) Patent Application Publication
(10) Pub. No.: US 2017/0279561 A1
(43) Pub. Date: Sep. 28, 2017

(54) BASE STATION DEVICE AND TERMINAL DEVICE

(71) Applicant: Sharp Kabushiki Kaisha, Sakai City, Osaka (JP)

(72) Inventors: Osamu NAKAMURA, Sakai City (JP); Jungo GOTO, Sakai City (JP); Yasuhiro HAMAGUCHI, Sakai City (JP)

(21) Appl. No.: 15/506,866

(22) PCT Filed: Aug. 28, 2015
(86) PCT No.: PCT/JP2015/074424

§ 371 Date: Feb. 27, 2017

(30) Foreign Application Priority Data
Oct. 3, 2014 (JP) 2014-204511

(51) Int. Cl. H04L 1/06; H04B 7/06; H04B 7/208; H04L 5/00

(52) U.S. Cl. CPC H04L 1/0668; H04L 5/0046; H04B 7/066; H04B 7/208

(57) ABSTRACT

Symbol replica precision is improved when symbol-level cancellation is performed in a receiver in downlink non-orthogonal access. Transmission is performed by multiplexing a transmission scheme by which excellent performance is obtained during demodulation and a transmission scheme by which excellent performance is obtained during decoding. Provided is a base station device including an addition unit that adds a number of signals the number exceeding a number of transmit antenna ports at the same time and the same frequency, and performing transmission from one or more transmit antenna ports. The addition unit adds signals generated by mutually different transmission schemes. Provided is a terminal device that receives a signal in which a number of signals generated by mutually different transmission schemes are added, the number exceeding a number of transmit antenna ports, at the same time and the same frequency. The terminal device includes a demodulation unit that performs demodulation processing for at least one of the mutually different transmission schemes, a replica generation unit that generates a symbol replica by using an output from the demodulation unit, and a cancellation unit that subtracts the symbol replica from the received signal.

### TECHNICAL FIELD

The present invention relates to a base station device and a terminal device.

### BACKGROUND ART

In recent years, smartphones and tablet terminals have been used widely and accordingly wireless traffic rapidly increases. Fifth generation mobile networks (5G) have been researched and developed to cope with the rapid increase in the traffic.

In downlink of LTE (Long Term Evolution) or LTE-A (LTE-Advanced), an access scheme (orthogonal multiple access) called OFDMA (Orthogonal Frequency Division Multiple Access) is used in which multiple narrow-band carriers (sub-carriers) are allocated to be orthogonal to each other. On the other hand, a non-orthogonal multiple access technique has been studied intensively as an access technique for 5G. In the non-orthogonal multiple access, a signal having no orthogonality is transmitted on the assumption that interference cancellation or reception processing such as maximum likelihood estimation is to be performed by a receiver. As an example of the non-orthogonal multiple access intended for downlink, DL-NOMA (Downlink Non-Orthogonal Multiple Access) has been proposed (PTL 1 and PTL 2). In the DL-NOMA, a base station device (also referred to as eNB (evolved Node B) or a base station) multiplexes and transmits modulation symbols addressed to a plurality of different terminal devices (also referred to as UE (User Equipment), mobile station devices, mobile stations, or terminals). At this time, transmit power for each of the modulation symbols is decided in consideration of receive power (reception quality) in the terminal devices for multiplexing. A terminal device is able to extract only a modulation symbol to the terminal device itself by decoding and cancelling signals addressed to different terminal devices among transmitted signals that are multiplexed. Note that, a terminal device that is not able to decode a signal to a different terminal device regards the signal to the different terminal device as noise and performs demodulation and decoding. At this time, the base station device decides an appropriate MCS (Modulation and Coding Scheme, a modulation scheme and a coding rate) for the terminal device that is not able to perform the cancellation in consideration of deterioration in reception quality.

### CITATION LIST

### Patent Literature

PTL 1: Japanese Unexamined Patent Application Publication No. 2013-9288

PTL 2: Japanese Unexamined Patent Application Publication No. 2013-9289

### SUMMARY OF INVENTION

### Technical Problem

In the DL-NOMA, it is necessary to notify a terminal that performs modulation, decoding, and cancellation for a signal to a different terminal of an MCS of the different terminal. However, when the MCS of the different terminal to be multiplexed by the DL-NOMA is also notified in addition to MCS of the terminal itself, there is a problem that an amount of control information of downlink increases and an information data amount that is able to be transmitted in downlink is reduced.

The invention has been made in view of such circumstances, and an object thereof is to provide a system in which DL-NOMA is performed without increasing control information by conducting cancellation without notifying a MCS of a different terminal in a DL-NOMA system.

### Solution to Problem

A terminal device and a base station device according to the invention for solving the aforementioned problem are as follows.

(1) A base station device of the invention includes an addition unit that adds a number of signals, the number exceeding a number of transmit antenna ports at the same time and the same frequency, the signals being transmitted from one or more transmit antenna ports, in which the addition unit adds signals generated by mutually different transmission schemes.

(2) In signals transmitted by the base station device of the invention, the signals generated by the mutually different transmission schemes include a signal generated by spread processing and a signal generated without applying spread processing.

(3) The mutually different transmission schemes used for transmission by the addition unit of the base station device of the invention include at least a SC-FDMA transmission scheme and an OFDM transmission scheme.

(4) The mutually different transmission schemes used for addition by the addition unit of the base station device of the invention include a transmission scheme by which a plurality of streams are able to be transmitted and a transmission scheme by which only one stream is transmitted.

(5) The mutually different transmission schemes used for addition by the addition unit of the base station device of the invention are generated by applying mutually different precoding operations.

(6) The mutually different transmission schemes used for addition by the addition unit of the base station device of the invention include a transmission scheme that applies transmission diversity and a transmission scheme that does not apply transmission diversity.

(7) The transmission diversity is generated by Alamouti code.

(8) A terminal device of the invention receives a signal in which a number of signals generated by mutually different transmission schemes are added, the number exceeding a number of transmit antenna ports, at the same time and the same frequency. The terminal device includes a demodulation processing unit that performs demodulation processing for at least one of the mutually different transmission schemes, a replica generation unit that generates a symbol replica by using an output from the demodulation unit, and a cancellation unit that subtracts the symbol replica from the received signal.

(9) The terminal device of the invention further includes a despread unit that performs despread processing for at least one of the mutually different transmission schemes.

(10) In the terminal device of the invention, the demodulation unit outputs a soft decision value, and the replica generation unit generates a soft replica.

### Advantageous Effects of Invention

According to the invention, since DL-NOMA can be performed without notifying a MCS of a different terminal, cell throughput or user throughput is able to be improved.

### BRIEF DESCRIPTION OF DRAWINGS

FIG. 1 illustrates an example of a communication system.

FIG. 2 illustrates an example of a configuration of a conventional transmission device.

FIG. 3A illustrates an example of a signal point constellation for a terminal device 103.

FIG. 3B illustrates an example of a signal point constellation for a terminal device 102.

FIG. 4 illustrates an example of a signal point constellation of signals transmitted by a base station device 101.

FIG. 5 illustrates an example of a configuration of an OFDM transmission processing unit.

FIG. 6 illustrates an example of a configuration of a conventional reception device.

FIG. 7 illustrates an example of a configuration of an OFDM reception signal processing unit.

FIG. 8 illustrates an example of a configuration of a transmitter according to a first embodiment.

FIG. 9A illustrates an example of a spectrum of a signal to the terminal device 102.

FIG. 9B illustrates an example of a spectrum of a signal to the terminal device 103.

FIG. 10 illustrates an example of a configuration of a receiver according to the first embodiment.

FIG. 11 illustrates an example of a configuration of a transmitter according to a second embodiment.

FIG. 12 illustrates an example of a modification of a configuration of a receiver according to the second embodiment.

FIG. 13 illustrates an example of a configuration of a receiver according to the second embodiment.

FIG. 14 illustrates an example of a configuration of a transmitter according to a third embodiment.

FIG. 15 illustrates an example of a configuration of a receiver according to the third embodiment.

### DESCRIPTION OF EMBODIMENTS

### First Embodiment

A communication system in the present embodiment includes at least one base station device (a transmission device, a cell, a transmission point, a transmit antenna group, a transmit antenna port group, a component carrier, or an evolved Node B (eNB)) and a plurality of terminal devices (terminals, mobile terminals, reception points, reception terminals, reception devices, receive antenna groups, receive antenna port groups, or User Equipment (UE)).

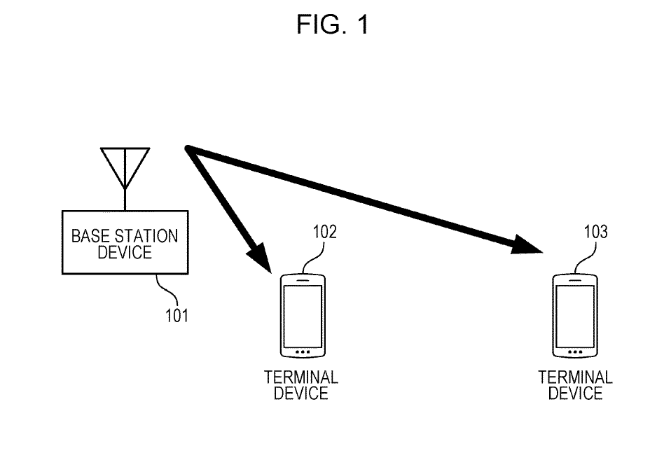

FIG. 1 is a schematic view illustrating an example of downlink (forward link) of a cellular system according to the first embodiment of the invention. In the cellular system of FIG. 1, one base station device (eNB) 101 exists, and a terminal device 102 and a terminal device 103 that are connected to the base station device 101 exist. The base station device 101 multiplexes signals to the terminal device 102 and the terminal device 103 and transmits the resultant in the same sub-carrier.

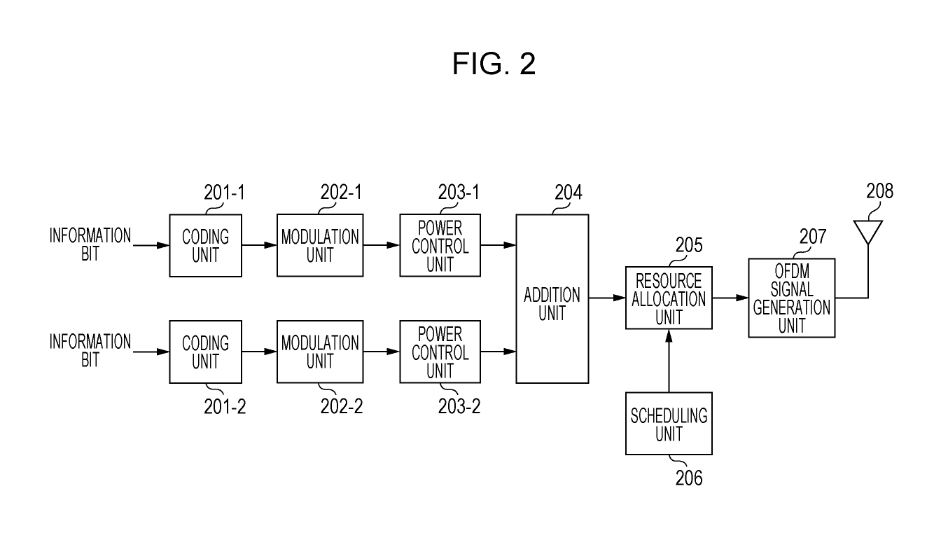

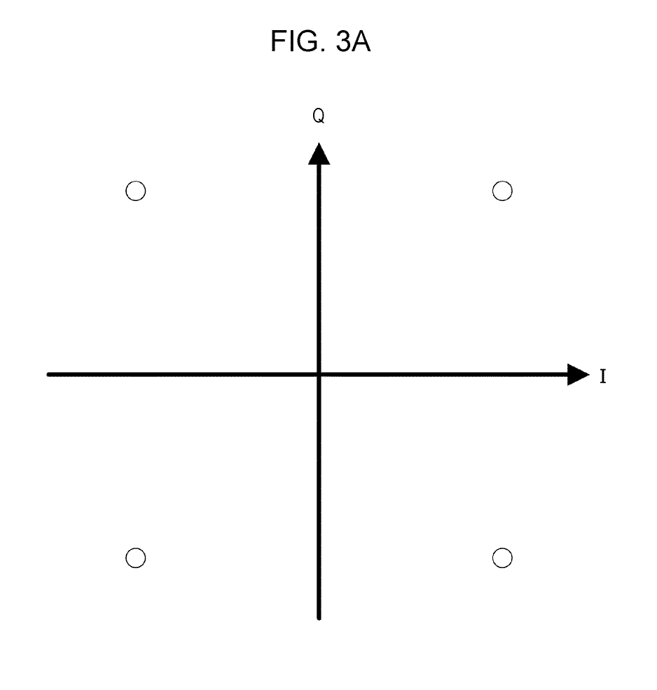

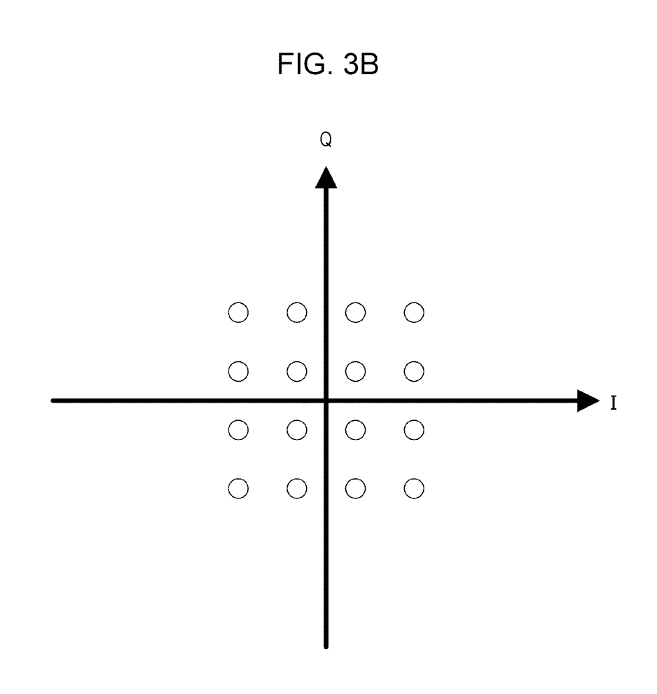

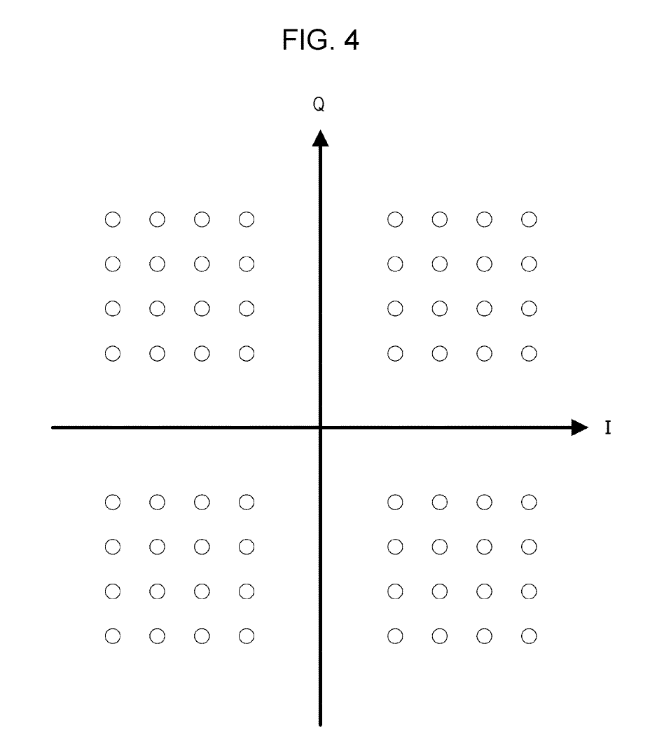

FIG. 2 is a block diagram illustrating an example of a configuration of a transmitter of the conventional base station device 101 that performs DL-NOMA. In FIG. 2, the number of signals to be multiplexed is two. Information bits are input to a coding unit 201-1 and a coding unit 201-2 and subjected to error correction coding. Note that, the coding units 201-1 and 201-2 may perform processing such as bit interleaving. The error correction coding bits are input to a modulation unit 202-1 and a modulation unit 202-2 and subjected to processing for converting a bit sequence to a symbol sequence. The symbol to be generated here is QPSK, 16QAM, 64QAM, or the like and different modulations may be applied in the modulation unit 202-1 and the modulation unit 202-2. Note that, a modulation scheme to be used is decided, for example, by information about a MCS input from a scheduling unit 206. Further, each terminal device is notified of information about a MCS of a terminal device by a control information channel. Note that, at least the terminal device 102 is notified of information about a MCS of the terminal device 103 in addition to a MCS of the terminal device 102. Outputs from the modulation unit 202-1 and the modulation unit 202-2 are respectively input to a power control unit 203-1 and a power control unit 203-2. The power control unit 203-1 and the power control unit 203-2 perform power control so that a total value of average powers of the outputs from the modulation unit 202-1 and the modulation unit 202-2 is a predetermined value. This power control may be decided in advance or decided in consideration of cell throughput, user throughput, or the like by the scheduling unit 206 and performed by values input to the power control unit 203-1 and the power control unit 203-2. Outputs from the power control unit 203-1 and the power control unit 203-2 are input to an addition unit 204. The addition unit 204 combines inputs from the power control unit 203-1 and the power control unit 203-2. For example, considered is a case where the output from the power control unit 203-1 is a QPSK symbol with high power (amplitude) illustrated in FIG. 3A and the output from the power control unit 203-2 is a 16QAM symbol with low power (amplitude) illustrated in FIG. 3B. Note that, a horizontal axis and a vertical axis in FIG. 3 are respectively an I axis and a Q axis, and respectively represent an in-phase component and a quadrature component. Though four symbol points and sixteen symbol points are respectively described in the QPSK and the 16QAM, any one point is actually output by a coding bit sequence output by the coding unit 201-1 or 201-2. In a case where signal candidate points of FIGS. 3A and 3B are respectively generated by the power control units 203-1 and 203-2, signal candidate points as illustrated in FIG. 4 are generated by the addition unit 204. An output from the addition unit 204 is input to a resource allocation unit 205. The resource allocation unit 205 arranges a signal output from the addition unit 204 in a predetermined sub-carrier in accordance with allocation information input from the scheduling unit 206. When the terminal device 102 and the terminal device 103 use different resource allocation, however, it becomes necessary to notify also resource allocation of terminal devices to be multiplexed. In the present example, a case where common resource allocation is used by terminal devices to be multiplexed (signal addition) will be described. Note that, all the signals are subjected to signal addition by the addition unit 204 in FIG. 2, but there is no limitation thereto and the output from the modulation unit 202-1 or the modulation unit 202-2 may be input to the resource allocation unit 205. An output from the resource allocation unit 205 is input to an OFDM signal generation unit 207. An output from the OFDM signal generation unit 207 is input to the terminal device 102 and the terminal device 103 via a transmit antenna 208.

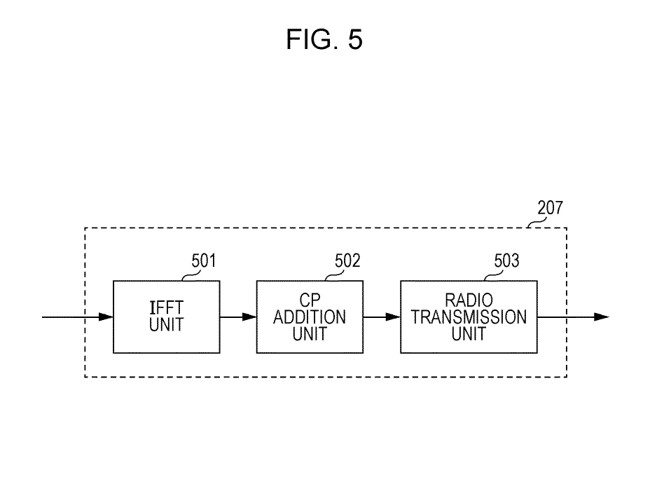

FIG. 5 illustrates an example of a configuration of the OFDM signal generation unit 207. The OFDM signal generation unit 207 generates an OFDM signal as a multicarrier. The output from the resource allocation unit 205 is input to an IFFT unit 501. The IFFT unit 501 performs processing for converting a frequency domain signal to a time domain signal. An output from the IFFT unit 501 is input to a CP addition unit 502 and subjected to addition of a CP. An output from the CP addition unit 502 is input to a radio transmission unit 503 and subjected to processing such as D/A conversion, filtering, up-conversion, or power amplification. An output from the OFDM signal generation unit 207 is input to the terminal device 102 and the terminal device 103 via the transmit antenna 208 of FIG. 2.

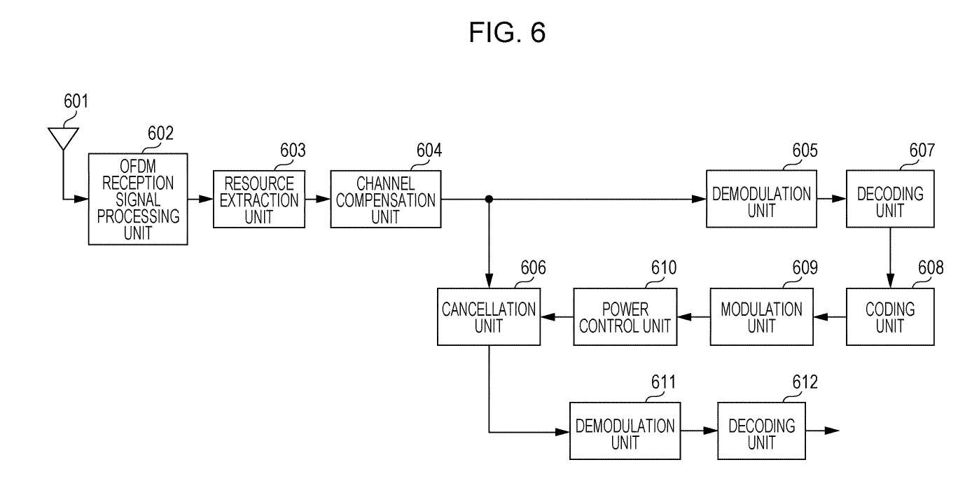

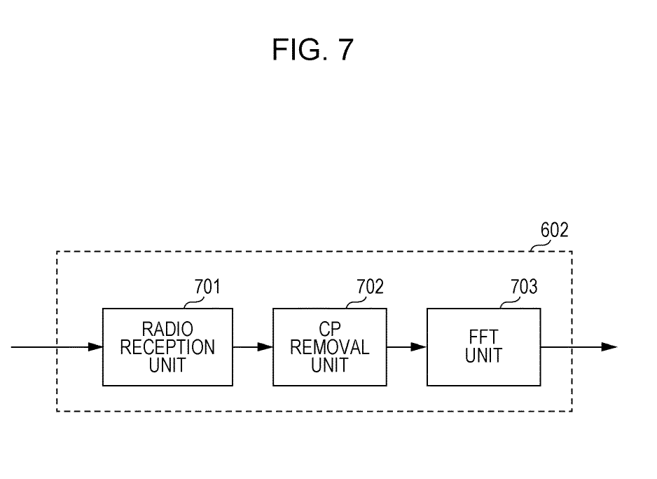

FIG. 6 illustrates a conventional example of a configuration of a receiver of the terminal device 102 that receives a signal subjected to DL-NOMA. A signal received via a receive antenna 601 is input to an OFDM reception signal processing unit 602. FIG. 7 illustrates an example of a configuration of the OFDM reception signal processing unit 603. The received signal is input to a radio reception unit 701 and subjected to processing such as down-conversion, filtering, or A/D conversion. An output from the radio reception unit 701 is input to a CP removal unit 702 and the CP inserted on a transmission side is removed. An output from the CP removal unit 702 is input to a FFT unit 703 and subjected to conversion from a time domain signal to a frequency domain signal by the FFT. An output from the FFT unit 703 is input to a resource extraction unit 603 of FIG. 6. The resource extraction unit 603 extracts a resource (sub-carrier) in which a signal to the terminal device 102 is allocated. Note that, information necessary for the resource extraction is generated by the scheduling unit 206 of FIG. 2 and notified to the terminal device 102 by a control information channel separately from the information bit. Note that, the control information channel refers to a PDCCH (Physical Downlink Control Channel), an EPDCCH (Enhanced PDCCH) or the like in the LTE.

An output from the resource extraction unit 603 is input to a channel compensation unit 604. The channel compensation unit 604 performs channel estimation by a DMRS (Demodulation Reference Signal), a CRS (Cell-specific Reference Signal), or the like and compensates influence received by a channel with an obtained channel estimation value. An output from the channel compensation unit 604 is input to a demodulation unit 605 and a cancellation unit 606. The demodulation unit 605 performs demodulation by a modulation scheme (the QPSK in the case of FIG. 3) used in the terminal 101. Note that, the terminal device 102 is notified of the MCS of the terminal device 103 as described above. An output from the demodulation unit 605 is input to a decoding unit 607 and subjected to decoding on the basis of information about the MCS of the terminal device 103. An information bit sequence to the terminal device 103, which is obtained through the decoding, is input to a coding unit 608 and coded again. A coding rate here is decided on the basis of the information about the MCS of the terminal device 103. That is, the coding unit 608 performs similar processing to that of the coding unit 201-1 of FIG. 2. An output from the coding unit 608 is input to a modulation unit 609 and subjected to modulation on the basis of information about the MCS of the signal addressed to the terminal device 103. That is, the modulation unit 609 performs similar processing to that of the modulation unit 202-2 of FIG. 2. An output from the modulation unit 609 is input to a power control unit 610. In this case, a control value in the power control unit 610 may be notified from the base station device 101 or may be estimated from a reference signal such as the DMRS or the CRS. That is, ideally, the power control unit 610 performs similar processing to that of the power control unit 203-2 of FIG. 2 and outputs a modulation symbol of FIG. 3A. An output from the power control unit 610 is input to the cancellation unit 606. The cancellation unit 606 subtracts (cancels) the signal addressed to the terminal device 103, which is output from the power control unit 610, from the signal input from the channel compensation unit 604 and thereby obtains only the signal addressed to the terminal device 102, in other words, ideally, a modulation symbol of FIG. 3B. An output from the cancellation unit 606 is input to a demodulation unit 611 and subjected to demodulation on the basis of the MCS of the terminal device 102. By applying error correction decoding to an output from the demodulation unit 611 by the decoding unit 612, an information bit sequence to the terminal device 102 is obtained.

In this manner, in a conventional DL-NOMA system, at least a terminal device in which a signal to a different terminal device is assumed to be cancelled needs to be notified of a MCS that is used for communication by the different terminal device from the base station device. Of course, there is a limit on types of the MCS and hence all MCSs of the different terminal device may be tried, but it is not realistic because an enormous amount of calculation is required in consideration of decoding processing.

Thus, there is a technique called SLIC (Symbol-Level Interference Cancellation) in which a signal to the different terminal device is not subjected to processing up to the decoding processing but is subjected to only the demodulation processing, a replica is generated on the basis of a demodulation result, and cancellation processing is performed. Since the decoding processing is not performed in the SLIC, it is not necessary to grasp a coding rate of the different terminal. In addition, in a case where a modulation scheme of the different terminal is one of about three types of the QPSK, the 16QAM, and the 64QAM, it is able to estimate the modulation scheme from statistical property or the like, so that the DL-NOMA is able to be introduced without notifying the terminal device of the information about the MCS of the different terminal from the base station device.

In a case where a signal replica of the different terminal is not generated from a decoding result but the replica is generated from a demodulation result, however, precision of the replica may be insufficient and the cancellation may not be performed appropriately. Though there is a terminal that is able to correctly demodulate the signal of the different terminal, such a terminal device needs to have extremely high reception quality. As a result, the number of combinations of terminals that are able to perform the DL-NOMA is limited and an effect of applying the DL-NOMA is reduced.

Thus, it is considered in the present embodiment that among signals multiplexed in the DL-NOMA, at least a remote terminal device (having low reception quality) performs communication not with the OFDM but with a transmission scheme in which a signal is spread in a frequency domain and/or a time domain.

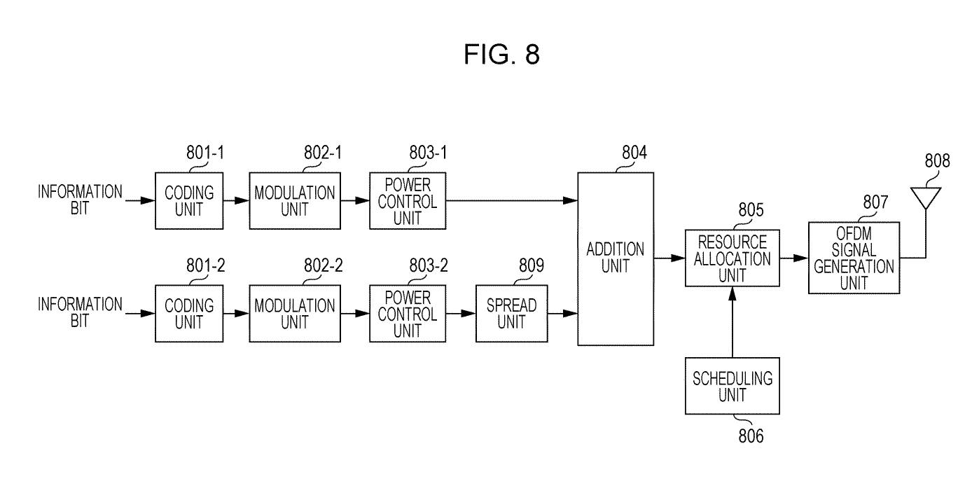

FIG. 8 illustrates an example of a configuration of a transmitter of the base station device according to the present embodiment. Similarly to FIG. 2, the number of signals multiplexed in the DL-NOMA is two in FIG. 8, but the number is not limited thereto and three or more signals may be multiplexed. Moreover, though description will be given by assuming that the number of transmit antennas is one, it is also possible to use an existing multi-antenna technique such as SU-MIMO (Single User Multiple Input Multiple Output) and MU-MIMO (Multi-User MIMO) in combination. Note that, the antenna may mean a physical antenna or an antenna formed by a plurality of antennas. The latter is defined as an antenna port in 3GPP. FIG. 8 is different from FIG. 2, which indicates a conventional configuration, in that whether or not a spread unit 809 exists, so that this point will be described. Note that, a position at which the spread unit 809 is inserted is not limited thereto and may be inserted after a modulation unit 802-2.

An output sequence of a power control unit 803-2 is spread by the spread unit 809. In the present embodiment, a case where spread and multiplexing by a DFT matrix are performed will be described as an example of a spread method. Note that, the present embodiment is not limited thereto, and frequency spread by a Walsh-Hadamard code or frequency spread by an M sequence may be performed, that is, an output from the spread unit 809 may be a MC-CDM (Multi-Carrier Code Division Multiplexing) signal or time spread may be performed by these codes. Further, frequency spread and time spread may be combined. That is, the invention also includes a case where a signal of DS-CDM (Direct Sequence CDM) or MC-DS-CDM, or a signal of NxDFTS-OFDM that is a signal obtained by applying DFT spread for each of a plurality of sub-bands (resource block groups or resource blocks) is output by the spread unit 809.

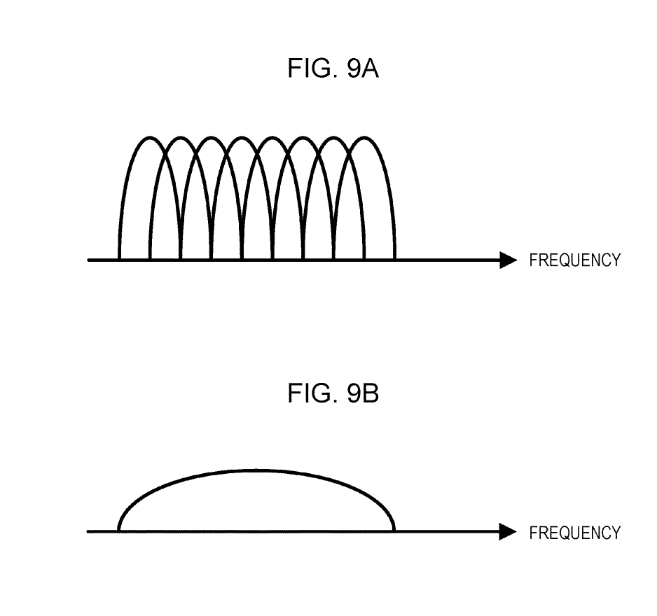

Next, an input to an addition unit 804 will be described. A power amplification unit 803-1 outputs a spectrum as illustrated in FIG. 9A. FIG. 9A illustrates an example in which a spectrum is configured by eight sub-carriers. Here, the modulation symbol of FIG. 3A constitutes each of the sub-carriers.

On the other hand, the spread unit 809 performs spread and multiplexing by a DFT matrix for an output from the power control unit 803-2, that is, an OFDM signal. In other words, a certain sub-carrier of the OFDM is spread by a corresponding column vector of the DFT matrix and another sub-carrier is spread by another corresponding column vector. The spread sub-carriers are multiplexed to thereby generate a transmission spectrum. This is generally called DFT-spread-OFDM (DFT-S-OFDM). The DFT-S-OFDM is also called DFT-precoded-OFDM, SC-FDM (Single Carrier Frequency Division Multiplexing), broadband single carrier transmission, or simply single carrier transmission. In this manner, a transmitter of the base station device of the present embodiment includes the spread unit 809 and hence multiplexes spectra of FIG. 9A and FIG. 9B.

Note that, though the spread unit 809 is provided in FIG. 8 only for processing of the signal addressed to the terminal device 103, the present embodiment is not limited thereto and spread processing may be performed also for the terminal device 102. Here, the spread processing for the signal to the terminal device 103 may be the same as the spread processing for the terminal device 102, or may be performed with the same reference (that is, for example, a sequence number of a spread code is different) as that of the spread processing for the terminal device 102, or a domain for the spread may be different between a time domain and a frequency domain.

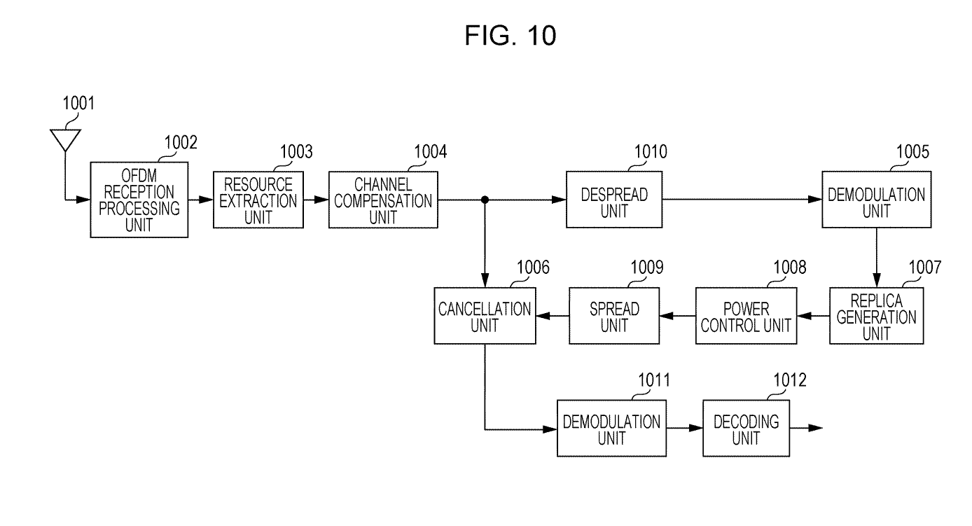

Next, a configuration of a receiver of the terminal device according to the present embodiment will be described. FIG. 10 illustrates an example thereof. Processing up to processing of a channel compensation unit in FIG. 10 is similar to that of FIG. 6, so that the description thereof will be omitted. However, since a channel compensation unit 1010 performs channel compensation also for a signal which has been subjected to spread and multiplexing, it is desired to apply weight considering this point and that an OFDM symbol of the terminal device 102 is multiplexed. An output from the channel compensation unit 1004 is input to a despread unit 1010 and a cancellation unit 1006 in FIG. 10.

Despread processing corresponding to processing of the spread unit 809 of FIG. 8 is applied in the despread unit 1010. When DFT spread is applied in the spread unit 809 of FIG. 8, IDFT processing is applied in the despread unit 1010. Symbols which are spread into a broadband by the DFT processing are able to be combined by the IDFT processing. For example, in a case where a channel has frequency-selective fading, information transmitted by a sub-carrier in which a gain drops becomes error due to noise in the OFDM, but average quality is able to be obtained by despread processing even when a sub-carrier in which the gain drops exists in the transmission in which the spread is applied. The effect is generally called a frequency diversity effect.

An output from the despread unit 1010 is input to a demodulation unit 1005. The demodulation unit 1005 performs, for a signal addressed to the terminal 103, demodulation processing, that is, conversion processing using a soft decision value from a symbol sequence to a bit sequence. In this case, the terminal device 102 is not necessarily notified from the base station device 101 of a modulation scheme used for transmission, and the modulation scheme in use is able to be estimated by means of an existing technique. The demodulation unit 1005 performs demodulation processing in accordance with the estimated modulation scheme. Note that, the modulation scheme may be estimated or notified from the base station device 101. It is also necessary to consider what power control is applied in the base station device 101, and this may be notified from the base station device 101 or estimated by using a reception reference signal. Note that, influence of the power control may be considered by the channel compensation unit 1004 as described above.

An output from the demodulation unit 1005 is input to a replica generation unit 1007. The replica generation unit 1007 generates a symbol replica by using a bit sequence input from the demodulation unit 1005. In this case, as the symbol replica, a hard replica may be generated from bit information obtained through hard decision of a soft decision bit sequence which is input or a soft replica according to likelihood of the soft decision bit sequence which is input may be generated.

The symbol replica output by the replica generation unit 1007 is input to a power control unit 1008 and subjected to similar processing to that of the power control unit 610 of FIG. 6. An output from the power control unit 1008 is input to a spread unit 1009 and subjected to spread processing. Here, as the spread processing, the same spread processing as the spread processing performed by the spread unit 809 of FIG. 8 is applied. That is, the DFT processing is performed in the present embodiment. An output from the spread unit 1009 is input to a cancellation unit 1006.

The cancellation unit 1006 subtracts the output of the spread unit 1009 from the output of the channel compensation unit 1004. As a result, only a spectrum to the terminal device 102 is able to be extracted from a spectrum in which the spectrum to the terminal device 102 and a spectrum to the terminal device 103 are combined. For example, only the spectrum of FIG. 9A is able to be extracted from a spectrum in which the spectrum of FIG. 9A and the spectrum of FIG. 9B are combined.

An output from the cancellation unit 1006 is output to a demodulation unit 1011. Subsequent processing is similar to that of a conventional configuration illustrated in FIG. 6 and therefore the description thereof will be omitted.

As described above, in the transmitter of the present embodiment, spread processing is applied to a remote terminal device (that is, a terminal device having low reception quality) to generate a signal and the signal is added to (combined with) a signal to a near terminal device (that is, a terminal device having high reception quality), and the resultant is transmitted. By applying spread processing for generation of the signal to the remote terminal device, also when the near terminal device does not apply decoding to signal processing of the remote terminal device, it is possible to obtain excellent transmission performance through the frequency diversity effect by the spread. That is, in comparison to a case where the spread processing is not applied to the remote terminal device of OFDM or the like, it is possible to generate a replica with high precision when error correction decoding is not applied, thus enabling cancellation processing to be performed appropriately. As a result, since many terminal devices are able to perform communication by the DL-NOMA, the cell throughput increases. Further, while only one terminal device is able to perform transmission per one sub-carrier in the orthogonal multiple access like FDMA, a plurality of terminal devices are able to perform transmission by sharing the same sub-carrier in the DL-NOMA, and therefore a transmission opportunity of each terminal device is increased. Accordingly, it is also possible to increase the user throughput.

Here, conventionally, there has been MU-MIMO as a technique by which a plurality of terminal devices perform transmission by sharing the same sub-carrier. The MU-MIMO requires a plurality of transmit antennas, whereas even one transmit antenna allows two or more terminals to perform transmission by sharing the same sub-carrier at the same time in the DL-NOMA. Further, it is also possible to combine the DL-NOMA and the MU-MIMO, and the invention is effective in this case as well.

Further, when a single carrier signal is generated by using the DFT in the spread unit 809, it is possible to reduce a PAPR (Peak to Average Power Ratio) of a transmission signal compared to that of the OFDM. As a result, since the base station device 101 does not need to include an expensive amplifier, it is possible to produce an inexpensive base station device. This effect is more remarkable when the number of antennas (or the number of antenna ports) increases.

The addition unit 804 is arranged before an OFDM signal generation unit 807 in FIG. 8, but may be arranged after the OFDM signal generation unit 807. That is, addition processing may be performed in a time domain. Here, the addition processing in a time domain indicates that the addition unit is arranged following the IFFT unit 501.

Note that, in a case where three or more terminal devices are multiplexed, expected throughputs are calculated by considering a case where the spread processing is performed and a case where the spread processing is not performed in each of the terminals, and a multiplexing scheme in which a calculated value thereof is the highest is used to perform communication, thus it is possible to achieve the most excellent performance. However, since the method has a problem that the amount of calculation is enormous, a condition under which the spread processing is applied only to the most remote terminal and the spread processing is not performed for other terminal devices may be given or a condition under which the spread processing is not applied to the nearest terminal device and the spread processing is performed for other terminal devices may be given.

### Second Embodiment

The first embodiment indicates that spread processing is applied to a remote terminal device (that is, having low reception quality). The following two points are considered in this case. First, compared to a transmission scheme such as the OFDM in which spread is not performed, in a transmission scheme in which spread is performed, a coding gain is reduced by an inter-symbol interference caused by frequency-selective fading, and therefore transmission performance is generally deteriorated at a time of coding compared to the OFDM. Second, it is possible to obtain a frequency diversity effect at a time of uncoding in the transmission scheme in which spread is performed, thus the transmission scheme in which spread is performed can obtain more excellent transmission performance than that of the OFDM in which a frequency diversity effect is not able to be obtained. That is, the transmission performance is reversed between the transmission scheme in which spread is performed and the transmission scheme in which spread is not performed depending on whether or not error correction coding is performed.

That is, the invention is able to be applied to two, three, or more schemes in which superiority and inferiority are reversed depending on whether or not error correction coding is performed. In the present embodiment, a case where the invention is applied between MIMO transmission and SIMO transmission will be described.

As a method of transmitting data by using a plurality of transmit antennas, there are two techniques of MIMO transmission (so-called SU-MIMO transmission) in which a plurality of streams (layers) are transmitted and a method (so-called transmit antenna diversity or transmission diversity) in which only one stream is transmitted with increased reliability. For example, at a time when two transmit antennas are used, the data rate is same between a case where QPSK is transmitted when two streams are transmitted and a case where 16QAM is transmitted when only one stream is transmitted. Compared to the MIMO transmission in which coding with high error correction ability is used, the transmission diversity in which error correction coding is not performed achieves excellent performance. This is because the 16QAM is used in the case of the transmission diversity, a distance between signal points is short, and an absolute value of a bit LLR (Log-Likelihood Ratio) obtained upon demodulation is smaller than that of the QPSK; on the other hand, in the case of the MIMO transmission, when a signal is able to be demultiplexed appropriately (that is, has been subjected to spatial filtering) by processing (spatial filtering) by a receiver, demodulation of the QPSK is performed, so that an LLR of a great absolute value is able to be obtained, but when the signal is not able to be demultiplexed appropriately, an LLR of a small absolute value (or of false positive or negative) is obtained. In the error correction, since a coding gain is generally high as a variation in the LLR is great, the MIMO transmission achieves more excellent performance.

In the case of not performing the error correction, that is, in the case of uncoding, the performance of a sub-carrier having low orthogonality becomes burden when a plurality of streams are transmitted as described above, whereas a bit LLR of reduced errors in positive or negative is obtained in the case of the transmission diversity. As a result, as the error rate characteristics of a coding bit obtained by performing hard decision on an output LLR of a demodulation unit, the performance of MIMO transmission in which a plurality of streams are transmitted may degrade as compared to the performance of the transmission diversity in some cases. When the transmission diversity is performed, there is a gain by the transmission diversity, so that excellent transmission performance is able to be achieved without performing decoding.

Thus, an example in which the DL-NOMA is constituted by applying the transmission diversity whose performance at a time of uncoding is excellent to a remote terminal device (that is, having low reception quality) will be described in the present embodiment.

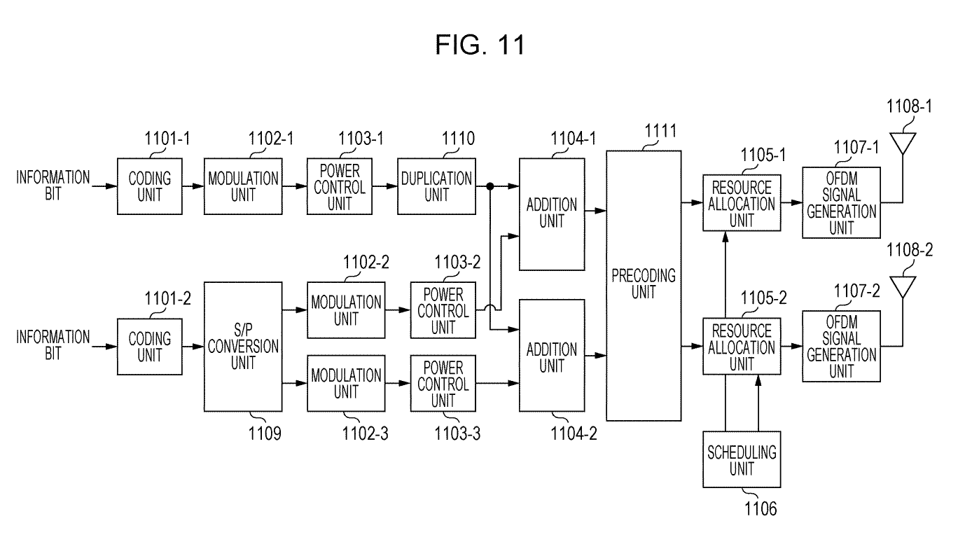

FIG. 11 illustrates an example of a configuration of a transmitter of the base station device of the present embodiment. Description will be given with an example when the MIMO transmission is performed for the terminal device 102 of FIG. 1 and the transmission diversity is performed for the terminal device 103. Note that, though description will be given for a case where the number of transmit antennas is two in FIG. 11, a case where transmission is performed by using three or more transmit antennas is also included in the present embodiment. An information bit sequence addressed to the terminal device 102 is input to a coding unit 1101-2 and an information bit sequence addressed to the terminal device 103 is input to a coding unit 1101-1. An output from the coding unit 1101-1 is directly input to a modulation unit 1102-1, whereas since a signal to the terminal device 102 is subjected to the MIMO transmission, an output from the coding unit 1101-2 is input to a S/P modulation unit 1109 and subjected to S/P (Serial to Parallel) conversion. Note that, though a configuration in which S/P conversion is performed after coding is provided in the present embodiment, the present embodiment is not limited thereto and may have a configuration in which S/P conversion is performed before coding.

An output from the S/P conversion unit 1109 is input to modulation units 1102-2 and 1102-3. Each of the modulation units 1102-1 to 1102-3 converts a bit sequence to a symbol sequence with a modulation scheme specified from a scheduling unit 1106. Outputs from the modulation units 1102-1 to 1102-3 are respectively input to power control units 1103-1 to 1103-3. The power control units 1103-1 to 1103-3 perform control so that power between layers of the MIMO transmission and power between signals multiplexed by the DL-NOMA have appropriate values. For example, for equalizing transmit power between the layers, it is only required to equalize power provided by the power control unit 1103-2 and the power control unit 1103-3. An output from the power control unit 1103-1 is input to a duplication unit 1110 and outputs from the power control unit 1103-2 and the power control unit 1103-3 are respectively input to an addition unit 1104-1 and an addition unit 1104-2.

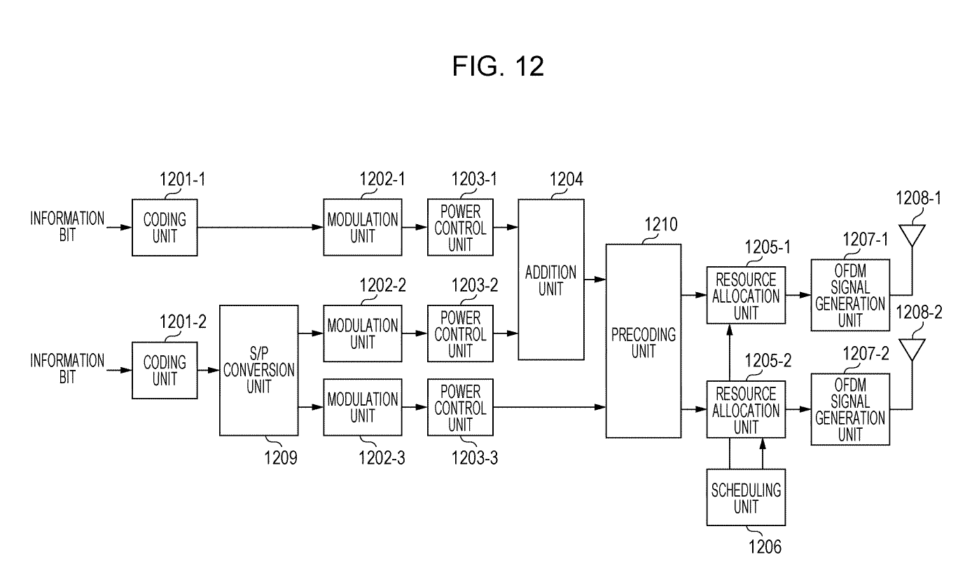

The duplication unit 1110 duplicates an input signal and inputs the resultant to the addition unit 1104-1 and the addition unit 1104-2. The addition unit 1104-1 adds (combines, sums up) an input from the duplication unit 1110 and an input from the power control unit 1103-2, and outputs the resultant to a precoding unit 1111. The addition unit 1104-2 adds (combines, sums up) an input from the duplication unit 1110 and an input from the power control unit 1103-3 and outputs the resultant to the precoding unit 1111. With processing at the addition units 1104-1 and 1104-2, the signal to the terminal device 103 and the signal to the terminal device 102 are transmitted by the DL-NOMA. Note that, though FIG. 11 indicates a configuration in which the signal to the remote terminal device is input to both of the two inputs to the precoding unit 1111 by the duplication unit 1110, the duplication unit 1110 may not be included. In this case, a transmitter has a configuration as illustrated in FIG. 12, for example. In the case of FIG. 12, an output from a power control unit 1203-1 is input only to an addition unit 1204. That is, control is performed so that more power is allocated by the power control unit 1203-1 than by other power control units in order to enhance reception quality of the remote terminal device 102.

Precoding processing is applied in the precoding unit 1111 to which outputs from the addition unit 1104-1 and the addition unit 1104-2 are input. The precoding processing is, for example, processing for multiplying an identity matrix, a DFT matrix, a Walsh-Hadamard matrix, a House-Holder matrix, or the like, and the matrix to be used may be selected in accordance with channel performance notified from each terminal device. In a case where the number of transmit antennas is larger than the number of transmission layers, that is, the number of inputs to the precoding unit 1111, a configuration of achieving the transmission diversity effect by combining with Alamouti code or the like may be used.

An output from the precoding unit 1111 is input to a resource allocation unit 1105-1 and a resource allocation unit 1105-2. The subsequent processing is similar to that of the first embodiment, so that the description thereof will be omitted. Note that, though not illustrated in FIG. 11, a reference signal needs to be transmitted for performing channel estimation in a receiver and the same precoding as that of data is applied also to the reference signal. When the receiver is able to grasp the precoding on a transmission side, however, the reference signal may be transmitted without performing the precoding.

In this manner, according to the configuration of the transmitter of the base station device indicated in the present embodiment, a signal is transmitted to the (remote) terminal device 103 having low reception quality by the transmission diversity and a plurality of streams are transmitted to the (near) terminal device 102 having high reception quality by using a plurality of transmit antennas while multiplexing is performed by the DL-NOMA with the terminal device 103 in a part of streams. As a result, when the SLIC is used, also the signal to the remote terminal device is easily cancelled in the near terminal device, and therefore an effect of applying the DL-NOMA is enhanced.

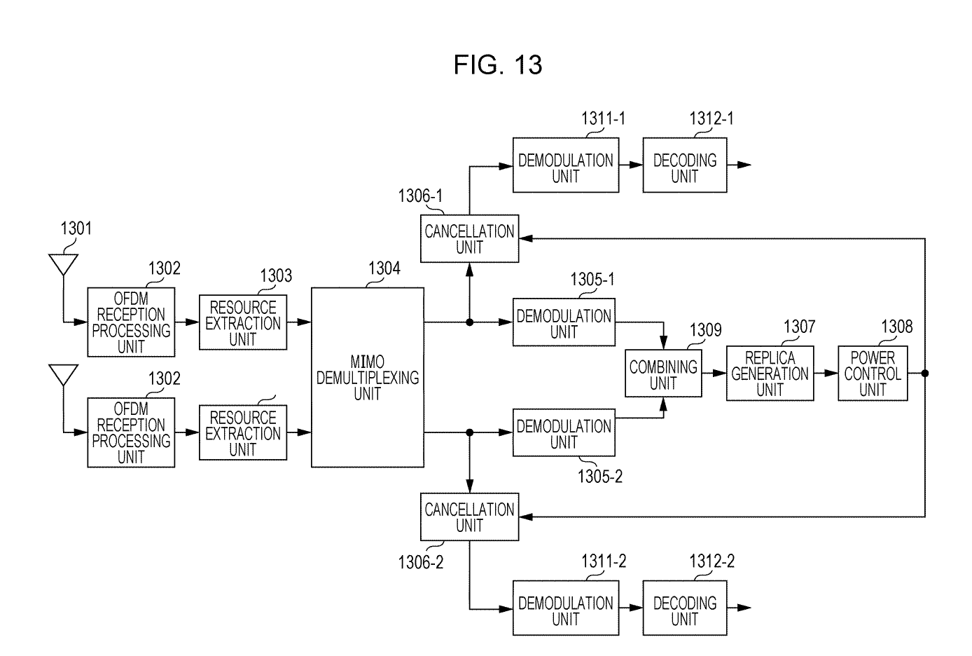

Next, a configuration of a receiver of the terminal device 102 according to the present embodiment, that is, the near terminal device will be described. FIG. 13 illustrates an example of the configuration. Received signals received by receive antennas 1301-1 and 1301-2 are respectively input to OFDM reception processing units 1302-1 and 1302-2. Configurations of the OFDM reception processing units 1302-1 and 1302-2 are similar to the OFDM reception processing unit described in FIG. 7. Outputs from the OFDM reception processing units 1302-1 and 1302-2 are respectively input to resource extraction units 1303-1 and 1303-2. The resource extraction units 1303-1 and 1303-2 extract sub-carriers that have been used for communication in a similar manner to those of FIG. 6 and FIG. 10. Outputs from the resource extraction units 1303-1 and 1303-2 are input to a MIMO demultiplexing unit 1304. The MIMO demultiplexing unit 1304 performs processing for demultiplexing a transmission signal combined by a channel. Here, a demultiplexing method used by the MIMO demultiplexing unit 1304 may be any method, and spatial filtering such as MMSE or ZF may be used or detection according to MLD may be performed. Note that, a channel estimation value used for spatial filtering, MLD, or the like is obtained by a channel estimation unit which is not illustrated.

An output from the MIMO demultiplexing unit 1304 is input to a demodulation unit 1305-1 and a demodulation unit 1305-2. The demodulation unit 1305-1 and the demodulation unit 1305-2 perform demodulation processing of a symbol on the basis of a modulation scheme applied in the modulation unit 1102-1 and power applied in the power control unit 1103-1. Outputs from the demodulation units 1305-1 and 1305-2 are input to a combining unit 1309. The combining unit 1309 performs combining, selection, or the like of likelihood of bit sequences input from the demodulation units 1305-1 and 1305-2. An output from the combining unit 1309 is input to a replica generation unit 1307. The replica generation unit 1307 generates a symbol replica.

Since the same signal is transmitted by two layers as the signal to the remote terminal device 103 as described above, when the combing unit 1309 combines the bit sequences in accordance with the likelihood, reliability of bits are able to be improved.

An output from the replica generation unit 1307 is input to a power control unit 1308. The power control unit 1308 performs similar processing to that of the power control unit 1103-1 of FIG. 11, and the obtained signal is input to cancellation units 1306-1 and 1306-2.

The cancellation units 1306-1 and 1306-2 subtract an output of the power control unit 1308 from the output of the MIMO demultiplexing unit 1304. With this processing, only signals output from the power control unit 1103-2 and the power control unit 1103-3 are able to be extracted respectively from signals combined by the additions units 1104-1 and 1104-2 of FIG. 11. The subsequent processing is similar to that of the first embodiment, so that the description thereof will be omitted.

Outputs from the cancellation units 1306-1 and 1306-2 are respectively input to demodulation units 1311-1 and 1311-2 and subjected to demodulation processing in consideration of control of the power control units 1103-2 and 1103-3. Bit sequences obtained through the demodulation processing are input to decoding units 1112-1 and 1112-2 and subjected to decoding processing on the basis of a coding rate notified from the base station. The decoding units 1112-1 and 1112-2 output the bit sequences obtained through the decoding as information bits.

In this manner, since not different signals but the same signal is transmitted with respect to the signal to be transmitted to the remote terminal device, the likelihood of bits are able to be increased by performing the combining in the receiver of the terminal device according to the present embodiment. As a result, it is possible to generate a replica with high precision even when the decoding is not performed. Accordingly, since the number of terminals that are able to cancel the signal of the remote terminal device increases, it is possible to enhance an effect of applying the DL-NOMA.

Note that, the present embodiment indicates a case where the same symbol is duplicated and transmitted with different precoding applied in order to obtain a gain by the transmission diversity. However, it is possible to enhance the likelihood of bits when error correction is not performed also by increasing transmit power of the remote terminal device without performing duplication as described in FIG. 11. That is, the invention also includes an example of carrying out a technique by which receive power is able to be improved by performing 1-layer communication without performing the MIMO transmission for the remote terminal device.

### Third Embodiment

Description has been given in the first embodiment for the base station device that applies spread processing to the signal addressed to the remote terminal device. When the base station device serving as a transmitter performs the spread processing, the terminal device serving as a receiver needs to perform despread processing. When the DFT is used for the spread processing, the IDFT is used for the despread processing, but in this case, a problem may arise as to which sub-carrier is to be subjected to the IDFT processing. When resource allocation is different between terminal devices participating in the DL-NOMA, it is considered that the near terminal device is notified of a DFT duration (that is, allocation information) of the signal to the remote terminal device, but control information increases when the allocation information is notified.

Thus, when the signal to the remote terminal device is spread, allocation to the remote terminal device and resource allocation to the near terminal device are considered to be matched. In this case, by applying despread processing with the resource allocation of the signal to the near terminal device, the near terminal device is able to perform appropriate despread processing for a signal to a different device (the remote terminal device).

However, matching the resource allocation between the signal to the remote terminal device and the signal to the near terminal device limits scheduling in the base station device, which reduces cell throughput.

Thus, the present embodiment describes a method of adaptively switching between a transmission method according to the first embodiment and a conventional transmission method in accordance with a scheduling method.

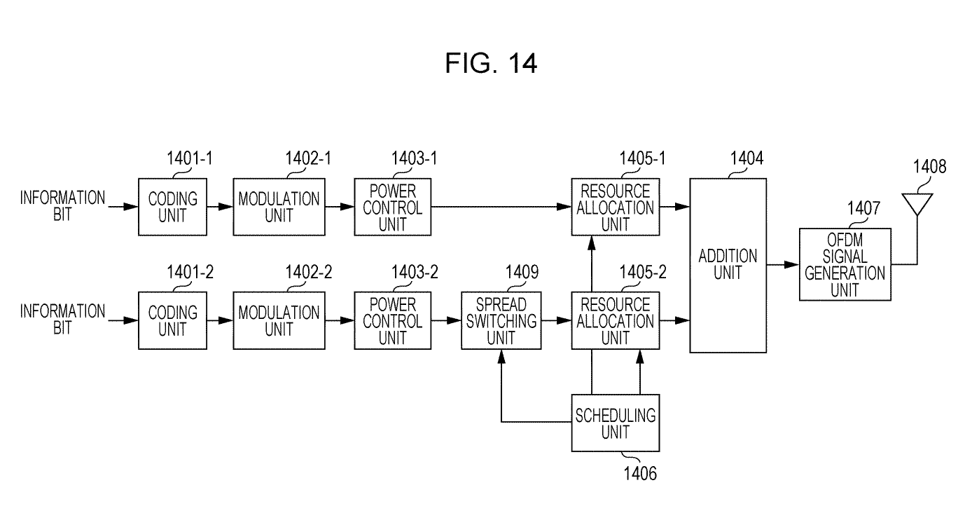

FIG. 14 illustrates an example of a configuration of a transmitter of the base station device according to the present embodiment. Processing up to power control units 1403-1 and 1403-2 is similar to that of the first embodiment, and therefore the description thereof will be omitted. An output from the power control unit 1403-1 is input to a resource allocation unit 1405-1. An output from the power control unit 1403-2 is input to a spread switching unit 1409. The spread switching unit 1409 switches between whether or not to perform spread of the DFT or the like in accordance with information about scheduling that is input from a scheduling unit 1406. For example, in downlink of the LTE, there are a method (contiguous arrangement, a resource allocation type 1) of allocating contiguous resource blocks and a method (non-contiguous arrangement, a resource allocation type 0) of allocating a resource block group (sub-band) non-contiguously. Since a frequency response of a channel is generally a frequency-selective fading channel, it is possible to select a resource block with a high gain by performing the non-contiguous arrangement. On the other hand, when an effect by scheduling is small, for example, when a moving speed of a terminal is high, it is considered to apply the contiguous arrangement. Moreover, since notification information increases when the non-contiguous arrangement is performed, it is considered to apply contiguous arrangement also when it is desired to suppress the amount of control information.

In a case where information input from the scheduling unit 1406 is, for example, information indicating the contiguous arrangement, the spread switching unit 1409 performs spread processing and inputs a signal after the spread processing to a resource allocation unit 1405-2. On the other hand, in a case where information input from the scheduling unit 1406 is information indicating the non-contiguous arrangement, the spread switching unit 1409 inputs the signal to a resource allocation unit 1405-2 without performing spread processing. In this manner, the spread switching unit 1409 decides whether or not to perform spread in accordance with the information about scheduling that is input from the scheduling unit 1406.

Next, processing in the scheduling unit 1406 will be described. As described above, the scheduling unit 1406 decides whether to perform resource allocation contiguously or non-contiguously by considering a moving speed, an amount of control information, and the like of the remote terminal device 103 and the near terminal device 102. In the case of the non-contiguous allocation, scheduling is applied separately to each of the terminal devices. On the other hand, in the case of the contiguous allocation, scheduling is performed for terminal devices participating in the DL-NOMA by common and contiguous arrangement. A result of the scheduling is input to the resource allocation unit 1405-1 and the resource allocation unit 1405-2.

Each processing in other blocks in a block diagram illustrated in FIG. 14 is similar to the above embodiments, and thus the description thereof will be omitted. However, an addition unit 1404 applies addition processing to a signal after resource allocation.

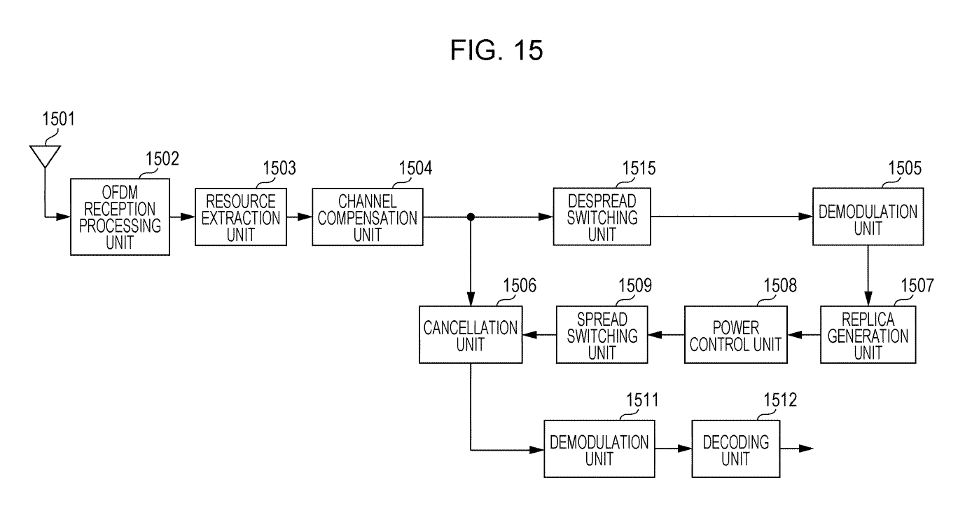

Next, FIG. 15 illustrates an example of a configuration of a receiver of the near terminal device 102 according to the present embodiment. FIG. 15 illustrates a configuration almost similar to that of FIG. 10. FIG. 15 is different from FIG. 10 in that a despread switching unit 1515 is provided instead of the despread unit 1010 and that a spread switching unit 1509 is provided instead of the spread unit 1009. Only those modified points will be described below.

The despread switching unit 1515 decides whether or not to perform despread in accordance with scheduling information notified from the base station device 101. That is, in a case where the scheduling information indicates the contiguous arrangement, signals that are spread in the same band are multiplexed, so that a signal to the remote terminal device is obtained by despread. Here, when the near terminal device is not notified of information indicating whether or not multiplexing by the DL-NOMA is performed, the signal after the despread has a small value, and therefore it is possible to prevent inappropriate cancellation processing from being performed, by generating a soft decision replica in a replica generation unit 1507. On the other hand, in a case where the scheduling information indicates the non-contiguous arrangement, signals in which signals subjected to spread processing are spread in the same band are not multiplexed and signals (that is, OFDM signals) for which spread is not performed may be multiplexed in each resource block. Thus, whether multiplexing is performed is determined for each reception resource block on the basis of statistical property or the like, and a resource block which is determined that multiplexing is performed therefor is directly input to a demodulation unit 1505, whereas a resource block which is determined that multiplexing is not performed therefor is weighted to have a small value or caused to have a value of zero, and input to the demodulation unit 1505. Note that, in the case of the non-contiguous arrangement, information indicating which resource block is determined that multiplexing is performed therefor is input from the despread switching unit 1515 to the spread switching unit 1509.

Next, the spread switching unit 1509 will be described. The spread switching unit 1509 decides whether or not to perform despread in accordance with scheduling information notified from the base station device 101. In the case of the contiguous arrangement, signals that are spread are multiplexed, and thus the spread switching unit 1509 applies spread processing. On the other hand, in the case of the non-contiguous arrangement, signals that are spread are not multiplexed and signals that are not spread are multiplexed, and therefore signals are arranged on the basis of multiplexing information input from the despread switching unit 1515 and signals to be canceled by a cancellation unit 1506 are generated.

In this manner, according to the present embodiment, the base station device decides whether or not to apply spread processing to the signal to the remote terminal device in accordance with a scheduling method. When scheduling allocation is notified and resource allocation information indicates the contiguous arrangement, the near terminal device generates a replica of the signal to the remote terminal device by performing despread, and when the resource allocation information indicates the non-contiguous arrangement, generates a replica of the signal to the remote terminal device without performing despread processing. In the case where a scheduling gain is thereby obtained, the non-contiguous arrangement is applied to the signals addressed to the remote terminal device and the near terminal device. On the other hand, when it is desired to reduce an amount of the control information by the resource allocation information or to increase the number of terminals capable of participating in the DL-NOMA by improving symbol-level cancellation by spread/despread, the contiguous arrangement is applied to the remote terminal device and the near terminal device. As a result, it is possible to perform control in consideration of a moving speed of the terminals, frequency-selective fading, a required amount of control information, desired throughput, and the like.

A program which runs in the base station device and the terminal device according to the invention is a program that controls a CPU and the like (program that causes a computer to function) such that the functions in the aforementioned embodiments concerning the invention are realized. The pieces of information handled by the devices are temporarily accumulated in a RAM during the processing thereof, and then stored in various ROMs and HDDs and read, corrected, and written by the CPU when necessary. A recording medium that stores the program therein may be any of a semiconductor medium (for example, a ROM, a nonvolatile memory card, or the like), an optical recording medium (for example, a DVD, an MO, an MD, a CD, a BD, or the like), a magnetic recording medium (for example, a magnetic tape, a flexible disc, or the like), and the like. Moreover, there is also a case where, by executing the loaded program, not only the functions of the aforementioned embodiments are realized, but also by performing processing in cooperation with an operating system, other application programs or the like on the basis of an instruction of the program, the functions of the invention may be realized.

When being distributed in the market, the program is able to be stored in a portable recording medium and distributed or be transferred to a server computer connected through a network such as the Internet. In this case, a storage device of the server computer is also included in the invention. A part or all of the terminal device and the base station device in the aforementioned embodiments may be realized as an LSI which is a typical integrated circuit. Each functional block of a reception device may be individually formed into a chip, or a part or all thereof may be integrated and formed into a chip. When each functional block is made into an integrated circuit, an integrated circuit control unit for controlling them is added.

Further, a method for making into an integrated circuit is not limited to the LSI and a dedicated circuit or a versatile processor may be used for realization. Further, in a case where a technique for making into an integrated circuit in place of the LSI appears with advance of a semiconductor technique, an integrated circuit by the technique is also able to be used.

Note that, the invention of the present application is not limited to the aforementioned embodiments. The terminal device of the present application is not limited to be applied to a mobile station device, but, needless to say, is applicable to stationary or unmovable electronic equipment which is installed indoors or outdoors such as, for example, AV equipment, kitchen equipment, cleaning/washing machine, air conditioning device, office appliances, automatic vending machine, other domestic equipment, and the like.

As above, the embodiments of the invention have been described in detail with reference to drawings, but specific configurations are not limited to the embodiments, and a design and the like which are not departed from the scope of the invention are also included in the scope of the invention.

### INDUSTRIAL APPLICABILITY

The invention is suitably used for a terminal device, a base station device, a communication system, and a communication method.

Note that, the present international application claims priority from Japanese Patent Application No. 2014-204511 filed on Oct. 3, 2014, and the entire contents of Japanese Patent Application No. 2014-204511 are hereby incorporated herein by reference.

### REFERENCE SIGNS LIST

101 base station device
102, 103 terminal device
201-1 to 201-2 coding unit
202-1 to 202-2 modulation unit
203-1 to 203-2 power control unit
204 addition unit
205 resource allocation unit
206 scheduling unit
207 OFDM signal generation unit
208 transmit antenna
501 IFFT unit
502 CP addition unit
503 radio transmission unit
601 receive antenna
602 OFDM reception signal processing unit
603 resource extraction unit
604 channel compensation unit
605 demodulation unit
606 cancellation unit
607 decoding unit
608 coding unit
609 modulation unit
610 power control unit
611 demodulation unit
612 decoding unit
701 radio reception unit
702 CP removal unit
703 FFT unit
801-1 to 801-2 coding unit
802-1 to 802-2 modulation unit
803-1 to 803-2 power control unit
804 addition unit
805 resource allocation unit
806 scheduling unit
807 OFDM signal generation unit
808 transmit antenna
809 spread unit
1001 receive antenna
1002 OFDM reception signal processing unit
1003 resource extraction unit
1004 channel compensation unit
1005 demodulation unit
1006 cancellation unit
1007 replica generation unit
1008 power control unit
1009 spread unit
1010 despread unit
1011 demodulation unit
1012 decoding unit
1101-1 to 1101-2 coding unit
1102-1 to 1102-3 modulation unit
1103-1 to 1103-3 power control unit
1104-1 to 1104-2 addition unit
1105-1 to 1105-2 resource allocation unit
1106 scheduling unit
1107-1 to 1107-2 OFDM signal generation unit
1108-1 to 1108-2 transmit antenna
1109 S/P conversion unit
1110 duplication unit
1111 precoding unit
1201-1 to 1201-2 coding unit
1202-1 to 1202-3 modulation unit
1203-1 to 1203-3 power control unit
1204 addition unit
1205-1 to 1205-2 resource allocation unit
1206 scheduling unit
1207-1 to 1207-2 OFDM signal generation unit
1208-1 to 1208-2 transmit antenna
1209 S/P conversion unit
1210 precoding unit
1301-1 to 1301-2 receive antenna
1302-1 to 1302-2 OFDM reception signal processing unit
1303-1 to 1303-2 resource extraction unit
1304 MIMO demultiplexing unit
1305-1 to 1305-2 demodulation unit
1306-1 to 1306-2 cancellation unit
1307 replica generation unit
1308 power control unit
1309 combining unit
1311-1 to 1311-2 demodulation unit
1312-1 to 1312-2 decoding unit
1401-1 to 1401-2 coding unit
1402-1 to 1402-2 modulation unit
1403-1 to 1403-2 power control unit
1404 addition unit
1405-1 to 1405-2 resource allocation unit
1406 scheduling unit
1407 OFDM signal generation unit
1408 transmit antenna
1409 spread switching unit
1501 receive antenna
1502 OFDM reception signal processing unit
1503 resource extraction unit
1504 channel compensation unit
1505 demodulation unit
1506 cancellation unit
1507 replica generation unit
1508 power control unit
1509 spread switching unit
1510 despread switching unit
1511 demodulation unit
1512 decoding unit

1. A base station device comprising
an addition unit that adds a number of signals the number exceeding a number of transmit antenna ports at the same time and the same frequency, the signals being transmitted from one or more transmit antenna ports, wherein
the addition unit adds signals generated by mutually different transmission schemes.

2. The base station device according to claim 1, wherein the signals generated by the mutually different transmission schemes include a signal generated by spread processing and a signal generated without applying spread processing.

3. The base station device according to claim 1, wherein the mutually different transmission schemes include at least a SC-FDMA transmission scheme and an OFDM transmission scheme.

4. The base station device according to claim 1, wherein the mutually different transmission schemes include a transmission scheme by which a plurality of streams are able to be transmitted and a transmission scheme by which only one stream is transmitted.

5. The base station device according to claim 1, wherein the mutually different transmission schemes are generated by applying mutually different precoding operations.

6. The base station device according to claim 1, wherein the mutually different transmission schemes include a transmission scheme that applies transmission diversity and a transmission scheme that does not apply transmission diversity.

7. The base station device according to claim 6, wherein the transmission diversity is generated by Alamouti code.

8. A terminal device that receives a signal in which a number of signals generated by mutually different transmission schemes are added, the number exceeding a number of transmit antenna ports at the same time and the same frequency, the terminal device comprising:
a demodulation unit that performs demodulation processing for at least one of the mutually different transmission schemes;
a replica generation unit that generates a symbol replica by using an output from the demodulation unit; and
a cancellation unit that subtracts the symbol replica from the received signal.

9. The terminal device according to claim 8, further comprising a despread unit that performs despread processing for at least one of the mutually different transmission schemes.

10. The terminal device according to claim 8 or 9, wherein the demodulation unit outputs a soft decision value, and the replica generation unit generates a soft replica.
